(19) United States
(12) Patent Application Publication
(10) Pub. No.: US 2009/0307344 A1
(43) Pub. Date: Dec. 10, 2009

(54) WEB PAGE RANKING METHOD AND SYSTEM BASED ON USER REFERRALS

(76) Inventors: Yuval KAPLAN, Tel Aviv (IL); Oren Kaplan, Ramat Efal (IL)

Correspondence Address: BROWDY AND NEIMARK, P.L.L.C.;624 NINTH STREET, NW, SUITE 300, WASHINGTON, DC, 20001-5303, US

(21) Appl. No.: 12/133,192

(22) Filed: Jun. 4, 2008

(51) Int. Cl. G06F 15/173

(52) U.S. Cl. 709/224

(57) ABSTRACT

A system and method for ranking web pages based on referrals sent from one user to another. Web pages that are sent to other users are tracked and their information is stored in a referral depository coupled to a referral server. Referral messages are also tracked when the recipient accesses the referred web page and when the recipient further refers the web page to another user. A ranking server can respond to a query regarding accessed web pages by accessing the referral depository and analyzing its contents.

### FIELD OF THE INVENTION

The present invention relates to Internet search engines and in particular to ranking web pages based on referrals sent from one user to another.

### BACKGROUND OF THE INVENTION

The Internet has become an important tool for many people providing them with enormous possibilities for obtaining information, entertainment and communication means. One of the main advantages of the Internet, the size and depth of all the information available, is also one of its biggest challenges as users struggle to locate and identify the most pertinent information (web page) for their needs.

This challenge can be answered in several ways. Content providers such as newspapers, portals, directories and the like perform an editorial work for presenting their users with what they think is the most important and pertinent information in the area they cover. By definition, these representations of information are limited in scope and are not meant to cover all the available information but rather a preferred selection.

Search engines in contrast aim to cover the largest possible number of web pages allowing the user to retrieve web pages matching specified search criteria. Typical search criteria include keywords with optional Boolean operators, for example, “low-fare flights”, “hotel New-York”, or “hotel AND Los-Angeles NOT Hilton”.

Typically, search engines rank web pages according to a variety of criteria such as inbound links from other web pages, or manual ranking by qualified human personnel. The relevance of a web page is determined by searched keywords in the web page or meta tags present in the web page and the way the web page is constructed.

In real life, people often rely on recommendations made by other people they know in order to make a selection or a decision. It would thus be highly desirable to integrate into an Internet search engine page ranking criteria that are based on human preference and behavior.

Content ranking systems based on user behavior and judgment are known in the art. For example, Attensa's International Application WO 2008-006107 describes an RSS feeder that can rank articles based on monitoring user interactions with each article. The user monitored interactions include reading an article, tagging, forwarding, emailing an article, etc. However, the application ranks documents in a closed, centralized system. It does not describe how to monitor behavior and rank content read independently of the ranking system.

Huang's International Application WO 2006-130985 and Yahoo's patent applications WO 2005-050278 and US 2005-0256866 all describe methods for searching web pages or sites based on user judgment, comments and/or annotations regarding the page or site. However, these methods only rank according to selected expert critics and they do not trace referral information among many users.

Chandra's US Patent Application 2008/0016164 discloses a process enabling a user to send a document via a web browser including the user's comments and highlights of the sent document, however the process does not track general referral information among many users.

Search engine ranking is a coveted feature that is prone to manipulation by automated applications (robots) that try to artificially improve the ranking of a web page by simulating features that increase the web pages rank. It would be desirable to have a search engine with a ranking that is not affected by such robots.

### SUMMARY OF THE INVENTION

It is an object of the present invention to provide a method for ranking web pages according to user behavior.

It is another object of the present invention to provide a method for ranking web pages according to the number of times a web page is referred from one user to another user and the number of times the receiving user opens the sent, referred web page, and to compensate the sender for referring the web page.

In one aspect, the present invention relates to a method for ranking web pages, the method comprising the steps of:

(i) detecting when a first user sends a referral message referring a web page to a second user;

(ii) detecting when said second user opens said referred web page; and

(iii) ranking said web pages according to the number of times that each said web page was referred and/or accessed by the second user.

The first user can refer a web page to the second user in different ways including but not limited to: an email message, a browser (browser functionality for referring a web page), a custom application, and/or a facility for referrals that is part of the web page.

In some cases, the first user (referring user) receives compensation when the second user (recipient) accesses the referred web page. The compensation may be monetary and/or non-monetary rewards. The non-monetary rewards comprise points redeemable for monetary compensation, products and/or services.

In one embodiment of the present invention, a referral message is conveyed only after the first user successfully passes a challenge-response test to determine that the referral is not generated by a computer.

In another embodiment of the present invention, a referral message is first sent directly from the sender's application to the recipient and the sender's application notifies a referral server that in turn writes the details of the referral message in a referral depository.

In yet another embodiment of the present invention, a request for the creation of a referral message is first sent to a referral server and then the referral server sends the referral message to the recipient. For example, the referral message can include a module for detecting when the referred web page is accessed by the second user. Such module comprises a second URL that directs to a handler in the referral server that in turn can read a key in the second URL that provides the referral server with an ID of the original reference URL and then it redirects the recipient's browser to this referred URL. Alternatively, such module comprises scripting language in the referral message such that it performs two actions: sending a notification to a referral server and directing the second user's browser to the referred URL.

In yet another embodiment of the present invention, the method further comprising the step of detecting when referrals are re-sent forming a new tree branch with the re-sent referral message information.

In a further embodiment of the present invention, a referral message comprises tree branch information tracked and maintained in the referral depository. The branching information comprises information about the width and depth of the referral message.

In another aspect, the present invention relates to a system for ranking web pages, comprising:

(i) a referring computer adapted for referring a web page;

(ii) a recipient computer adapted for receiving a web page;

(iii) a referral depository coupled to a referral server adapted for tracking when a referring computer sends a referral message referring a web page to a recipient computer, and when a recipient computer accesses the referred web page.

The term “computer” as used herein means any device such as a personal computer, laptop, server, mainframe, terminal, Personal Digital Assistant, smart phone, telephone enhanced with web browsing and text messaging capabilities (SMS, email, instant messages etc), game console or any other device that can browse a web page and send a message to another computer.

### BRIEF DESCRIPTION OF THE DRAWINGS

FIG. 1 is a flowchart of an embodiment of a web page ranking method according to the invention.

FIG. 2 is a block diagram of an embodiment of a ranking system wherein a first user sends a referral message directly to a second user.

FIG. 3 is a block diagram of an embodiment of a ranking system wherein a first user sends a request for a referral message to a ranking server that in turn sends the referral message to a second user.

### DETAILED DESCRIPTION OF THE INVENTION

In the following detailed description of various embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention.

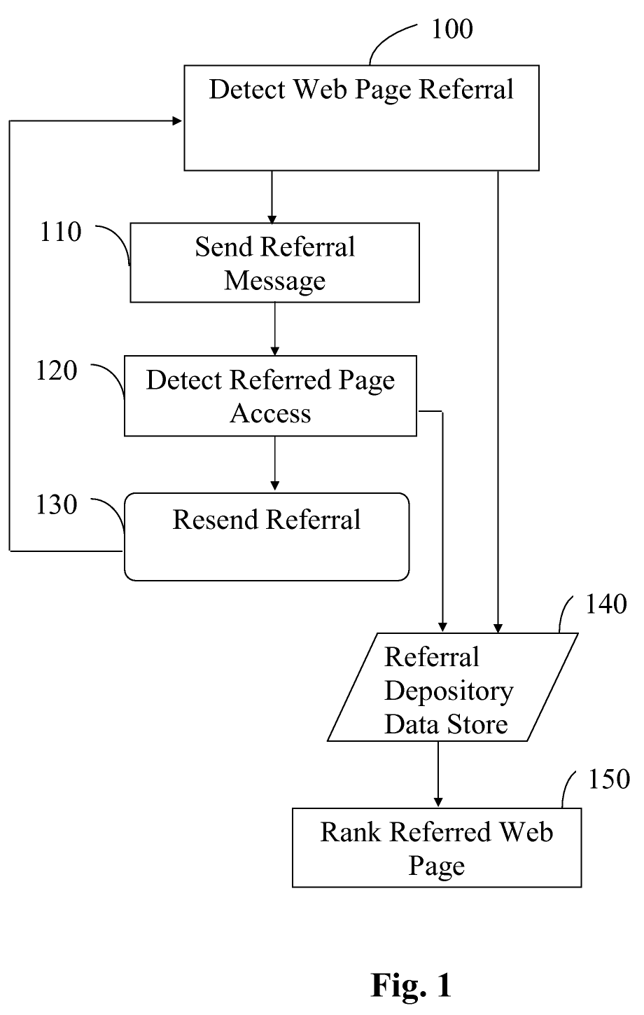

The present invention relates to a method for ranking web pages according to user behavior and to a system for implementing said method. FIG. 1 is a flowchart of an embodiment of a web page ranking method according to the invention. In step 100 the process starts by detecting when a user refers a web page to another user.

Step 110 involves sending the referral message from the sender to the recipient. When a user wishes to communicate a certain web page to another user, he can do it in a variety of ways including, but not limited to: sending an email with the Uniform Resource Locator (URL) of the desired web page; using a specific function in a browser in order to send a web page either as a link or sending the page itself; using a custom application for sending web pages; or using a facility within the web page itself. The custom application can be implemented either as an independent, stand-alone application or as a module of another application. A URL can reference a single web page or a group of web pages.

Information regarding the referred message is communicated through a referral server to a referral depository, typically via the Internet. The referral depository gathers information about all the referred web pages.

The referred message can be either in binary format or text format. In addition to the URL (or web page itself) and the sending and receiving party contact information, the referred message can include additional information including, but no limited to: a personal message from the sender to the recipient; comments regarding the referred content (web page); identification information of the sender: technical information regarding the message; identification information regarding the referred content: preferred language; or any additional information required.

In one embodiment of the present invention, a referral message is conveyed only after the sender successfully passes a challenge-response test to determine that the referral is not generated by a computer. The URL referenced by such a referral is given a higher weight (rank) in search results because it has a very high probability not to be generated by an automatic computer application used in order to artificially promote the ranking of a web page by generating bogus referrals. Such challenge-response tests are known in the art as “Completely Automated Public Turing test to tell Computers and Humans Apart” or CAPTCIHA. A CAPTCHA involves one computer (a server) asking a user to complete a simple test which the computer is able to generate and grade. Because other computers are unable to solve the CAPTCHA, any user entering a correct solution is presumed to be human.

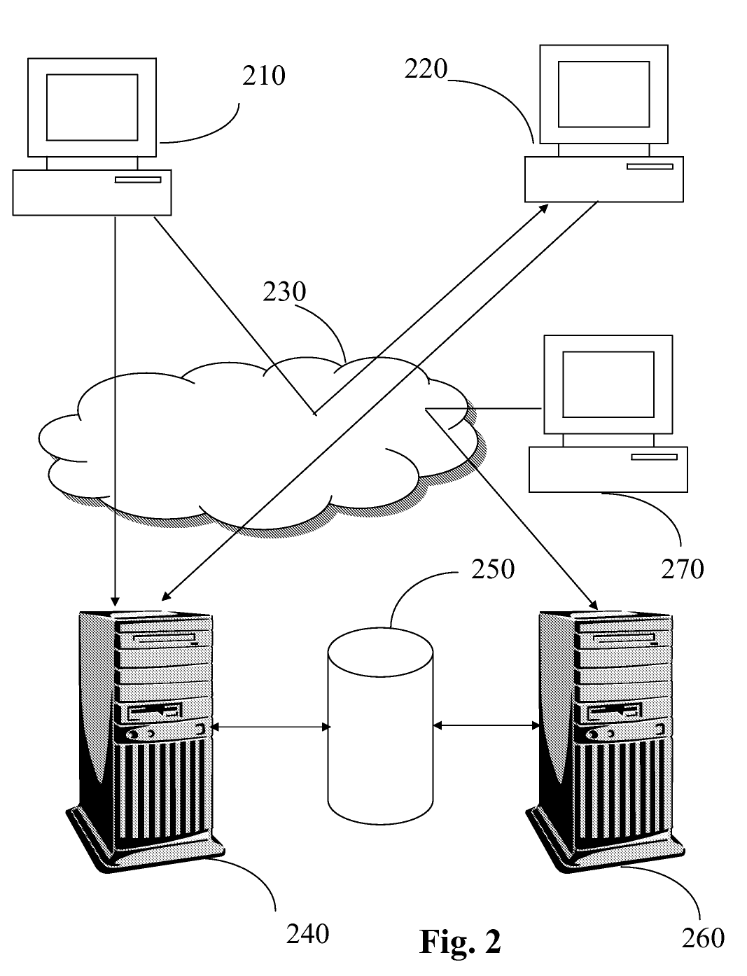

The detection when a URL is sent out can be implemented in many ways depending on how the URL is sent. FIG. 2 illustrates an embodiment of the present invention, wherein a referral message is sent directly from the sender's 210 application to the recipient 220 through the Internet 230. The sender's 210 application then notifies the referral server 240 coupled to the referral depository 250 of the referral message details.

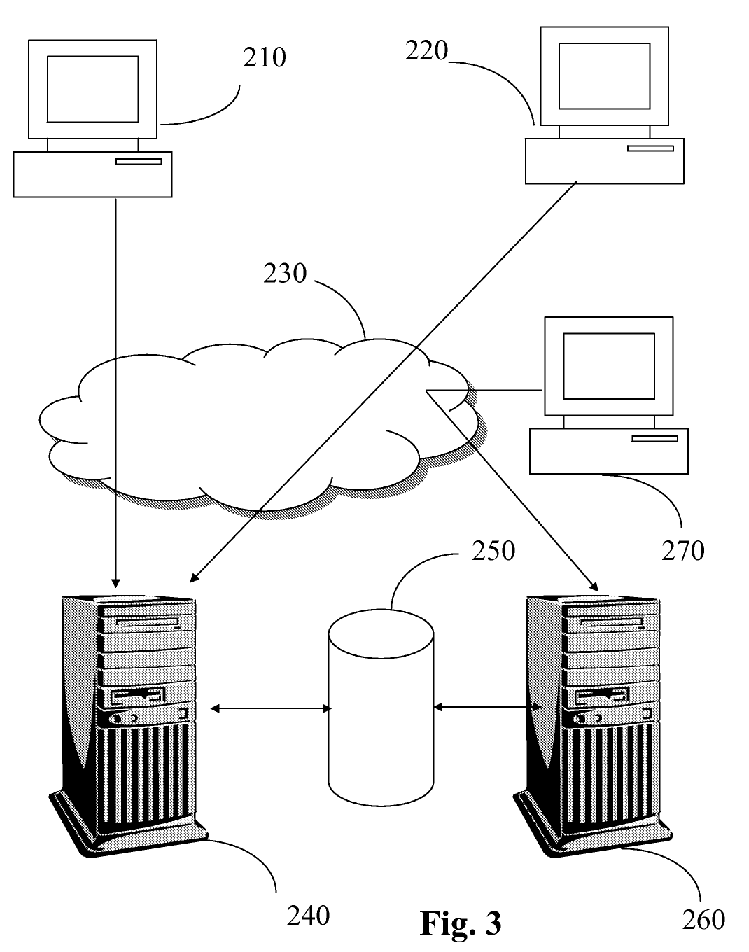

FIG. 3 illustrates yet another embodiment of the present invention, wherein the request for sending a referral message is sent directly from the sender's 210 application to the referral server 240 which in turn stores it in its referral depository 250 and also generates and sends the referral message to the recipient 220. For example, certain browsers and email programs allow adding extensions or add-ons and such added program code can be used to send and/or monitor sent links. Another way is for the web page itself to offer a facility for entering recipient's 220 details (optionally along with sender's 210 information), and monitors that the pages are sent.

The terms “sender, recipient, user” as used herein should be interpreted as the machine and application that generate the instructions on behalf of the sender and recipient and not as the human person itself.

Sending out a web page by a user 210 is a first indication of interest in the web page. However, the interest shown is much higher if the recipient 220 actually goes and opens the web page he receives.

Step 120 thus involves detecting when the second user 220 opens the received web page. For example, the receiving user 220 may be requested to install on his computer a module that detects when a received link is opened. Alternatively, the sent out message can include a special module that monitors when the sent URL is actually opened. For example, the referral message can be encoded with a URL that directs to a handler in the referral depository 250 that in turn can read a key in the URL that provides the referral depository 250 with an ID of the original reference URL and then redirects the recipient's 220 browser to this referred URL. Another alternative is to use a scripting language in the referral message such that it performs two actions: sending a notification to the referral depository 250 and directing the user's 220 browser to the referred URL. Information that a referred web page was actually accessed by the recipient 220 is thus communicated to the referral depository 250 by a message sent to the referral server.

Step 140 involves storing the information generated by steps 100 and 120 for future use in the referral depository 250.

Step 130 involves detecting if a referred message has been referred further by the recipient 220 and, if so, the new referred message is also tracked for ranking purposes. The interest (rank) is considered even higher if a branching (a new tree branch) of referral emerges when the receiving party 220 opens the referral message and then decides to refer it to other recipients 220 that in turn can refer the message again to other users 220. The higher the number of branches (referrals) and sub-branches (referrals of referrals) and their form also gives an indication as to the popularity of the web page. The form of the branches relates to the shape of the branching tree, for example, maybe few users referred the web pages to many recipients, or maybe many users referred the web page to a few recipients, etc. This form of branching can be stored in a balanced tree (B-Tree) which has a structure that is very useful in understanding the relationships between parent and descendant nodes and enables a simplified algorithm for insertion and extraction of nodes and their branches.

Each branched and sub-branched referral message contains pertinent information about the width and depth in the tree of said referral message. The width of a referred message indicates how many recipients were targeted by each sender, for example, John has referred this web page to 7 people (in a single referral message, width=7). The depth of a referral message indicates how many recipients have in turn referred the web page to other users, for example, John referred the web page to Harry that referred it to Bob that referred it to Sally (Depth=4).

Sometimes, the owner of a web page is willing to award a compensation for accessing his page. The compensation may be monetary or non-monetary. For example, a referring user 210 may receive a certain amount of points for referring a web page that was actually accessed by the recipient 220 of the referral. The points can later be redeemable for certain products or services either online or off-line. In one embodiment of the present invention, it is detected when a referring user 210 receives a compensation for referring a web page that was actually accessed by the recipient 220.

The ranking information about web pages that are referred from one user 210 to another user 220, about such web pages that are opened (accessed) by the receiving user 220 and about such web pages that involve a compensation for the referring user 210, all such information is accumulated in a referral depository 250, typically through the Internet 230. For example, via a Hypertext Transfer Protocol (HTTP) connection to an Internet address.

Step 150 involves ranking the referred web page according to different criteria so that it can properly match a user query in a search engine. A search engine uses the information accumulated in the referral depository 250 in order to conduct search operations that take this information into account. The search engine prioritizes (ranks) the search results according to one or more different criteria including but not limited to:
the number of times a URL has been referred with a challenge-response test to determine that the referral is not generated by a computer, as opposed to a referral message sent without such a test;
the number of recipients per referring message (the higher the number of recipients per message, the lower the ranking);
the number of times a referred URL has been accessed by the receiving party 220;
the number and formation (breadth and depth) in which referral messages are resent by recipients 220 to others; or
the number of times a referred and accessed URL involved compensation to the referring party 210.

The ranking server 260 analyzes the content of the sent web pages and categorizes them based on methods of web page categorization techniques known in the art. When a querying user 270 use the ranking server 260 to search for relevant web page data that has been stored in the referral depository 250, the ranking server 260 uses the categorization of the page to identify its relevance and uses the calculated weight of the page based on the criteria mentioned above to set its ranking compared to other relevant pages.

The ranking server 260 accesses the referral depository 250 in order to retrieve referral statistics on the relevant pages that can contribute to a calculation that will give weight to a page and thus set its rank. The ranking server 260 can be implemented as an independent server or application, or alternatively, be implemented as a module inside a search engine.

Tables 1 through 4 show examples of how the referral information can facilitate a ranking of two web pages that have been identified as having content that fits the categories that a querying user 270 is searching for. The first stage as shown in Table 1 is to calculate the score a page receives based on some of the criteria previously described (referral after CAPTCHA, opening of the referral and resending the referral). The score is derived by multiplying a set weight (or importance) by the number of occurrences of each of the criteria in each referral tree of the web page.

TABLE 1
Referral Tree

| | | Web Page A | | Web Page B | |
|---|---|---|---|---|---|
| Criteria | Weight | Count | Value | Count | Value |
| Referral sent (CAPTCHA | 2 | 4 | 8 | 2 | 4 |
| verified) | | | | | |
| Referral opened by recipient | 4 | 3 | 12 | 1 | 4 |
| Referral resent by recipient - | 3 | 2 | 6 | 3 | 9 |
| 2^{nd} Level | | | | | |
| Referral opened by recipient | 8 | 1 | 8 | 2 | 16 |
| Referral resent by recipient - | 4 | 0 | 0 | 1 | 4 |
| 3^{rd} Level | | | | | |
| Referral opened by recipient | 16 | 0 | 0 | 1 | 16 |
| Score | | | 34 | | 53 |

Once all the scores are calculated they are aggregated to generate the total referral tree scoring as shown in Table 2.

TABLE 2
Ranking based on Referral Trees Scoring

Score

| | Web Page A | Web Page B |
|---|---|---|
| | 34 | 53 |
| | 20 | 34 |
| | 56 | 37 |
| | 22 | — |
| | 20 | |
| Total Referral Tree Score | 152 | 124 |

The next stage shown in Table 3 is to consider the compensation effect on the referrer based on the number of referrals that were opened by a recipient 220 and the compensation amount and type offered. The combination of compensation type and amount can be weighed in to a compensation unit. The factor of compensation units offered by the web page owner and the number of opened referrals generate the total compensation effect.

TABLE 3
Effect of compensation

Compensation Effect

| | Web Page A | Web Page B |
|---|---|---|
| Units of compensation | 7 | 5 |
| (per opened referral) | | |
| Number of opened referrals | 30 | 25 |
| Total Compensation Effect | 210 | 125 |

The final stage shown in Table 4 includes the weighted aggregate of the two contributing ranking factors above to generate a value used to rank the pages against each other.

TABLE 4
Aggregated Ranking based on compensation and
Referral Trees Scoring

| | | Web | | Web | |
|---|---|---|---|---|---|
| | | Page A | | Page B | |
| Criteria | Weight | Total | Value | Total | Value |
| Compensation Effect | −1 | 210 | −210 | 125 | −125 |
| Referral Tree Score | +2 | 152 | 304 | 124 | 248 |
| Aggregated Ranking | | | 94 | | 123 |

The data that is considered can also be weighed in based on its age. The more up to date the referrals the more relevant they become to the page rank. Also, another factor that can be used to improve the ranking algorithm is the spacing between the time the referral was sent and the time it was opened and then between the time it was opened and the time it was resent.

Although the invention has been described in detail, nevertheless changes and modifications, which do not depart from the teachings of the present invention, will be evident to those skilled in the art. Such changes and modifications are deemed to come within the purview of the present invention and the appended claims.

1. A method for ranking web pages, comprising the steps of:
(i) detecting when a first user sends a referral message referring a web page to a second user;
(ii) detecting when said second user opens said referred web page; and
(iii) ranking web pages according to the number of times that each web page was referred and/or accessed by the second user.

2. A method according to claim 1, wherein the first user refers a web page to the second user using an email message, a browser, a custom application, or a facility that is part of the web page.

3. A method according to claim 1, wherein the first user receives compensation when said second user accesses the referred web page.

4. A method according to claim 3, wherein said compensation comprises monetary and /or non-monetary rewards.

5. A method according to claim 4, wherein said non-monetary rewards comprise points redeemable for monetary compensation, products and/or services.

6. A method according to claim 1, wherein the referral message is conveyed only after the first user successfully passes a challenge-response test to determine that the referral is not generated by a computer.

7. A method according to claim 1, wherein the referral message is first sent directly from the sender's application to the recipient and then the sender's application notifies a referral depository about the details of the referral message sent.

8. A method according to claim 1, wherein a request for creation of a referral message is first sent to a referral server and the referral server generates then and sends a referral message to the recipient.

9. A method according to claim 1, wherein said referral message includes a module for detecting when the referred web page is accessed by the second user.

10. A method according to claim 9, wherein said module comprises a second URL directing to a handler in the referral server that in turn can read a key in the second URL providing the referral server with an ID of the original reference URL and then said handler redirects the recipient's browser to the original reference URL.

11. A method according to claim 9, wherein said module comprises scripting language in the referral message such that it performs two actions: sending a notification to a referral depository and directing the second user's browser to the referred URL.

12. A method according to claim 1, further comprising the step of detecting when referral messages are re-sent forming a new tree branch with the re-sent referral message information.

13. A method according to claim 1, wherein a referral depository relates referral messages to re-sent referrals in order to generate branching information.

14. A method according to claim 13, wherein said branching information comprises information about the width and depth of the referral message.

15. A method according to claim 1, wherein ranking a web page is also based on the time it was referred.

16. A system for ranking web pages, comprising:
(i) a referring computer adapted for referring a web page;
(ii) a recipient computer; adapted for receiving a web page;
(iii) a referral depository coupled to a referral server adapted for tracking when a referring computer sends a referral message referring a web page to a recipient computer, and when a recipient computer access the referred web page.

17. A system according to claim 16, wherein the referring computer refers a web page to the recipient computer using an email message, a browser, a custom application, or a facility that is part of the web page.

18. A system according to claim 16, wherein the referring computer receives compensation when said recipient computer accesses the referred web page.

19. A system according to claim 18, wherein said compensation comprises monetary and/or non-monetary rewards.

20. A system according to claim 19, wherein said non-monetary rewards comprises points redeemable for monetary compensation, products and/or services.

21. A system according to claim 16, wherein the referral message is conveyed only after the referring computer successfully passes a challenge-response test to determine that the referral is not generated by a computer.

22. A system according to claim 16, wherein the referral message is first sent directly from the sender's application to the recipient and then the sender's application notifies a referral depository about the details of the referral message sent.

23. A system according to claim 16, wherein the referral message is first sent to a referral server and the referral server then sends a second referral message to the recipient.

24. A system according to claim 23, wherein said second referral message includes a module for detecting when the referred web page is accessed by the recipient computer.

25. A system according to claim 24, wherein said module comprises a second URL directing to a handler in the referral server that in turn can read a key in the second URL providing the referral server with an ID of the original reference URL and then said handler redirects the recipient's browser to the original reference URL.

26. A system according to claim 24, wherein said module comprises scripting language in the referral message such that it performs two actions: sending a notification to a referral depository and directing the recipient computer's browser to the referred URL.

27. A system according to claim 16, wherein referrals, that are re-sent forming a new tree branch with the re-sent referral message information, are detected.

28. A system according to claim 16, wherein a referral depository relates referral messages to re-sent referrals in order to generate branching information.

29. A system according to claim 28, wherein said branching information comprises information about the width and depth of the referral message.

30. A system according to claim 16, wherein ranking a web page is also based on the time it was referred.

31. A computer-readable medium encoded with a program module that ranks web pages referred from a first user to a second user, by::
(iv) detecting when a first user sends a referral message referring a web page to a second user;
(v) detecting when said second user opens said referred web page; and
(vi) ranking web pages according to the number of times that each web page was referred and/or accessed by the second user.
